(19) United States
(12) Patent Application Publication
(10) Pub. No.: US 2025/0301082 A1
(43) Pub. Date: Sep. 25, 2025

(54) FACSIMILE APPARATUS

(71) Applicant: FUJIFILM Business Innovation Corp., Tokyo (JP)

(72) Inventors: Hideo ISHIZU, Yokohama-shi (JP); Toshitsugu KIKUCHI, Yokohama-shi (JP); Kodai UMEDA, Yokohama-shi (JP)

(73) Assignee: FUJIFILM Business Innovation Corp., Tokyo (JP)

(21) Appl. No.: 18/764,485

(22) Filed: Jul. 5, 2024

(30) Foreign Application Priority Data
Mar. 21, 2024 (JP) 2024-044732

(51) Int. Cl. H04N 1/00; H04N 1/327

(52) U.S. Cl. CPC H04N 1/00901; H04N 1/32708; H04N 1/32763

(57) ABSTRACT

A facsimile apparatus includes a photo relay that switches a state of connection between an externally connected telephone set and a telephone line; a rectifying unit that rectifies a signal at a time when an incoming call from the telephone line arrives into DC power; a holding unit that holds the DC power obtained by rectification by the rectifying unit; and a switching controller that performs control in such a manner that supply of the DC power held in the holding unit to the photo relay causes the externally connected telephone set to be connected to the telephone line.

### CROSS-REFERENCE TO RELATED APPLICATIONS

This application is based on and claims priority under 35 USC 119 from Japanese Patent Application No. 2024-044732 filed Mar. 21, 2024.

### BACKGROUND

### (i) Technical Field

The present disclosure relates to a facsimile apparatus.

### (ii) Related Art

In Japanese Unexamined Patent Application Publication No. 5-191536, a communication apparatus that is capable of operating by electric power generated using a line current and a call signal supplied from a telephone line even when power is out, is disclosed.

### SUMMARY

In the case where a single telephone line is shared by a telephone set and a facsimile apparatus, a system configuration in which the facsimile apparatus is connected to the telephone line and the telephone set is connected to the facsimile apparatus is adopted. In this case, the telephone set is connected to the telephone line via the facsimile apparatus. Thus, typically, the facsimile apparatus switches, using a mechanical electromagnetic relay, connection of the telephone line to the telephone set. Such a mechanical electromagnetic relay includes a mechanical contact and thus typically has a short service life compared to other components mounted on an electronic system. Thus, the service life of the facsimile apparatus may be extended by replacing the mechanical electromagnetic relay with a photo relay that electrically switches connection. However, to maintain an electrical connection state, the photo relay requires electric power from the outside. Therefore, when power is out, the telephone line and the telephone set are not connected. As a result, the telephone set is unable to be used when the power is out. Even if an incoming call has arrived at the telephone set, the telephone set is unable to recognize the arrival of the incoming call.

Aspects of non-limiting embodiments of the present disclosure relate to providing a facsimile apparatus capable of, even in the case where a photo relay is used for switching a state of connection between an externally connected telephone set and a telephone line, enabling the telephone set to be used when an incoming call arrives at the telephone set in a power outage.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a facsimile apparatus including a photo relay that switches a state of connection between an externally connected telephone set and a telephone line; a rectifying unit that rectifies a signal at a time when an incoming call from the telephone line arrives into DC power; a holding unit that holds the DC power obtained by rectification by the rectifying unit; and a switching controller that performs control in such a manner that supply of the DC power held in the holding unit to the photo relay causes the externally connected telephone set to be connected to the telephone line.

### BRIEF DESCRIPTION OF THE DRAWINGS

Exemplary embodiments of the present disclosure will be described in detail based on the following figures, wherein:

FIG. 1 is a diagram illustrating a system configuration of an image forming system according to an exemplary embodiment of the present disclosure;

FIG. 2 is a block diagram illustrating a hardware configuration of an image forming apparatus according to an exemplary embodiment of the present disclosure;

FIG. 3 is a diagram illustrating a circuit configuration of a FAX module including a mechanical electromagnetic relay;

FIG. 4 is a diagram illustrating a circuit configuration of a facsimile (FAX) module in which a mechanical electromagnetic relay is replaced with a photo relay;

FIG. 5 is a diagram illustrating a circuit configuration of a FAX module in an image forming apparatus according to an exemplary embodiment of the present disclosure; and

FIG. 6 is a flowchart for explaining an operation of a microcontroller embedded with an FRAM (registered trademark) for the case where control using a delay setting time, which is a set value, held in the embedded FRAM is performed.

### DETAILED DESCRIPTION

Exemplary embodiments of the present disclosure will be described in detail with reference to drawings.

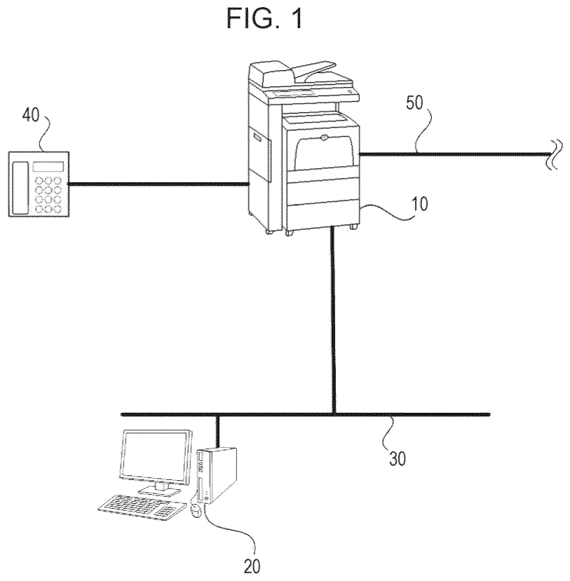

FIG. 1 is a diagram illustrating a system configuration of an image forming system according to an exemplary embodiment of the present disclosure.

As illustrated in FIG. 1, an image forming system according to an exemplary embodiment of the present disclosure includes an image forming apparatus 10, a terminal apparatus 20, and a telephone set 40 that is connected to the image forming apparatus 10. The image forming apparatus 10 and the terminal apparatus 20 are connected to each other by a network 30. The terminal apparatus 20 generates print data and transmits the generated print data to the image forming apparatus 10 via the network 30. The image forming apparatus 10 receives the print data transmitted from the terminal apparatus 20 and outputs an image corresponding to the print data onto paper. The image forming apparatus 10 is an apparatus that is called a so-called multifunction machine including multiple functions such as a printing function, a scan function, a copy function, and a facsimile function.

A telephone line 50 is connected to the image forming apparatus 10 so that facsimile transmission and reception is performed. In the system configuration illustrated in FIG. 1 in which the single telephone line 50 is shared by the telephone set 40 and the image forming apparatus 10, which is a facsimile apparatus, the telephone set 40 is connected to the image forming apparatus 10.

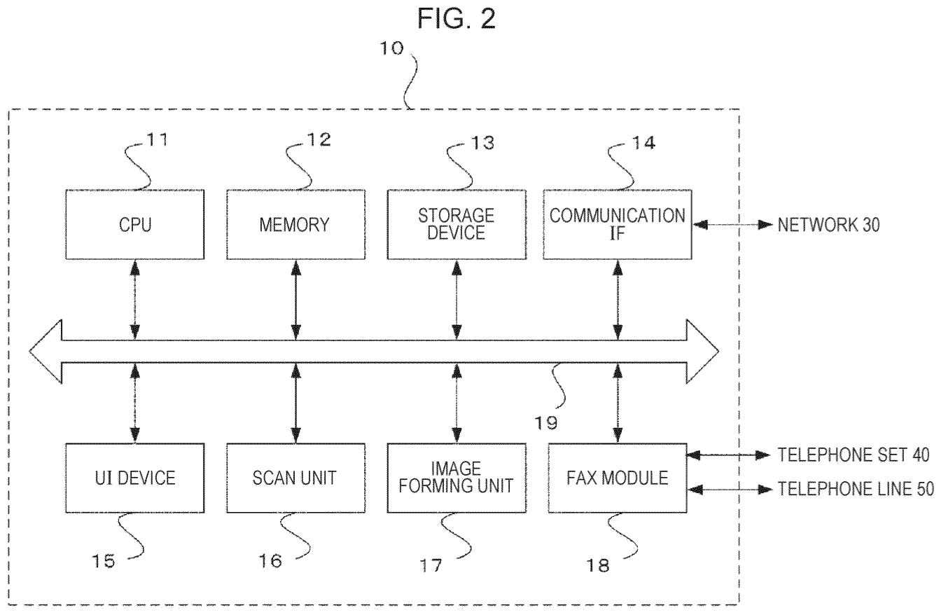

A hardware configuration of the image forming apparatus 10 in the image forming system according to an exemplary embodiment is illustrated in FIG. 2.

As illustrated in FIG. 2, the image forming apparatus 10 includes a central processing unit (CPU) 11, a memory 12, a storage device 13 such as a hard disk drive, a communication interface (IF) 14 that performs transmission and reception of data to and from an external apparatus via the network 30, a user interface (UI) device 15 including a touch panel or a liquid crystal display and a keyboard, a scan unit 16, an image forming unit 17, and a facsimile (FAX) module 18. The component elements mentioned above are connected to one another via a control bus 19.

The FAX module 18 is connected to the telephone line 50 and the telephone set 40. The FAX module 18 performs facsimile transmission and reception via the telephone line 50. The FAX module 18 also performs processing for connecting an incoming call from the telephone line 50 to the telephone set 40 and connecting an outgoing call from the telephone set 40 to the telephone line 50.

The CPU 11 is a processor that performs predetermined processing based on a control program stored in the memory 12 or the storage device 13 to control an operation of the image forming apparatus 10. In this exemplary embodiment, the CPU 11 has been described as a unit that reads the control program stored in the memory 12 or the storage device 13 and executes the control program. However, the CPU 11 is not limited to the one described above. The control program may be recorded in a computer-readable recording medium and provided. For example, the program may be recorded in an optical disc such as a compact disc-read only memory (CD-ROM) or a digital versatile disc-read only memory (DVD-ROM) or in a semiconductor memory such as a universal serial bus (USB) memory or a memory card and provided. Furthermore, the control program may be acquired from an external apparatus via a communication line connected to the communication IF 14. Moreover, for example, the control program may be provided as a single piece of application software or may be incorporated as a function of the image forming apparatus 10 into software of each apparatus.

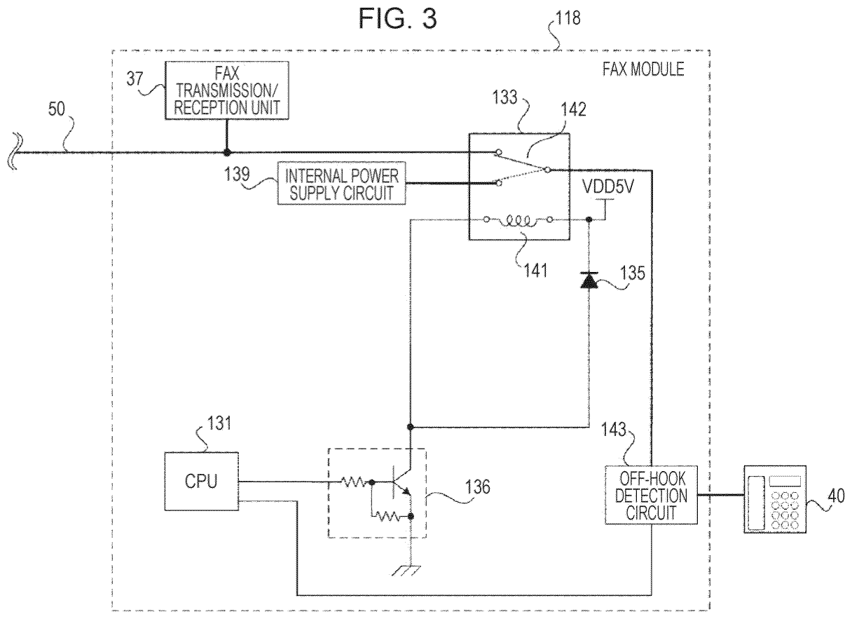

Next, before providing a description of a circuit configuration of the FAX module 18, a configuration of a FAX module 118 in a comparative example including a mechanical electromagnetic relay will be described with reference to FIG. 3.

The FAX module 118 in the comparative example illustrated in FIG. 3 includes a CPU 131, a mechanical electromagnetic relay 133, a diode 135, a digital transistor 136, a FAX transmission/reception unit 37, an internal power supply circuit 139, and an off-hook detection circuit 143.

The mechanical electromagnetic relay 133 includes a coil 141 and a single-pole double-throw contact part 142. The mechanical electromagnetic relay 133 is configured such that connection of the contact part 142 is mechanically switched according to application of current to the coil 141. Specifically, a line to the telephone set 40 is connected to the telephone line 50 in the case where current is not applied to the coil 141, and a line to the telephone set 40 is connected to the internal power supply circuit 139 in the case where current is applied to the coil 141.

One end of the coil 141 is connected to VDD 5V, which is a power supply voltage, and the other end of the coil 141 is connected to the digital transistor 136, which is a switching element. The digital transistor 136 is connected between the other end of the coil 141 and the ground. Thus, when the CPU 131 turns on the digital transistor 136, the other end of the coil 141 is connected to the ground potential and enters a current applied state. The diode 135 is connected to absorb a counter electromotive voltage that is generated when current is applied to the coil 141.

In a normal condition in which there is neither an outgoing call from the telephone set 40 nor an incoming call from the telephone line 50, the CPU 131 turns on the digital transistor 136 so that the telephone set 40 is disconnected from the telephone line 50 and is connected to the internal power supply circuit 139. Then, when the telephone set 40 enters an off-hook state, the off-hook state is detected by the off-hook detection circuit 143. When the off-hook detection circuit 143 detects that the telephone set 40 has entered the off-hook state, the CPU 131 turns off the digital transistor 136 and causes the coil 141 to enter the current applied state so that the telephone set 40 is connected to the telephone line 50.

The mechanical electromagnetic relay 133 configured as described above, which includes the mechanical contact part 142, typically has a short service life compared to other components mounted on the image forming apparatus 10. Thus, by replacing the mechanical electromagnetic relay 133 with a photo relay that electrically switches connection, the service life of the entire image forming apparatus 10 may be extended.

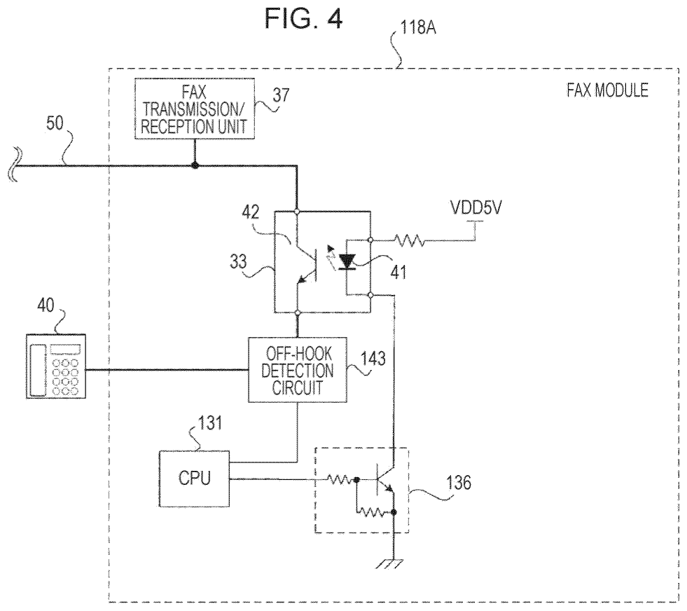

A FAX module 118A in which a mechanical electromagnetic relay is replaced with a photo relay is illustrated as a comparative example in FIG. 4.

The FAX module 118A illustrated in FIG. 4 is different from the FAX module 118 illustrated in FIG. 3 in that the mechanical electromagnetic relay 133 is simply replaced with a photo relay 33. The photo relay 33 is also called a photo coupler and includes a light-emitting element 41 such as a light-emitting diode and a light-receiving element 42. The photo relay 33 is configured such that current flowing to the light-emitting element 41 causes light to be incident to the light-receiving element 42 and causes the photo relay 33 to be turned on and a circuit connected to both ends of the light-receiving element 42 is electrically connected.

In a normal condition in which there is neither an outgoing call from the telephone set 40 nor an incoming call from the telephone line 50, the CPU 131 turns off the digital transistor 136 so that the telephone set 40 is disconnected from the telephone line 50. Then, when the telephone set 40 enters an off-hook state, the off-hook state is detected by the off-hook detection circuit 143. When the off-hook detection circuit 143 detects that the telephone set 40 has entered the off-hook state, the CPU 131 turns on the digital transistor 136 and causes the photo relay 33 to enter the current applied state so that the telephone set 40 is connected to the telephone line 50.

By switching connection between the telephone set 40 and the telephone line 50 using the photo relay 33, the service life of the FAX module is extended compared to the case where a mechanical electromagnetic relay is used. However, since external electric power is necessary for the photo relay 33 to maintain an electrically connected state, the telephone line 50 and the telephone set 40 are unable to be connected when power is out. As a result, when the power is out, the telephone set 40 is unable to be used. Even if an incoming call has arrived at the telephone set 40, a user of the telephone set 40 is not able to recognize the incoming call.

With the FAX module 18 of the image forming apparatus 10 according to this exemplary embodiment having a circuit configuration described below, even in the case where the photo relay 33 is used for switching between the externally connected telephone set 40 and the telephone line 50, the telephone set 40 is enabled to be used when an incoming call arrives at the telephone set 40 in a power outage.

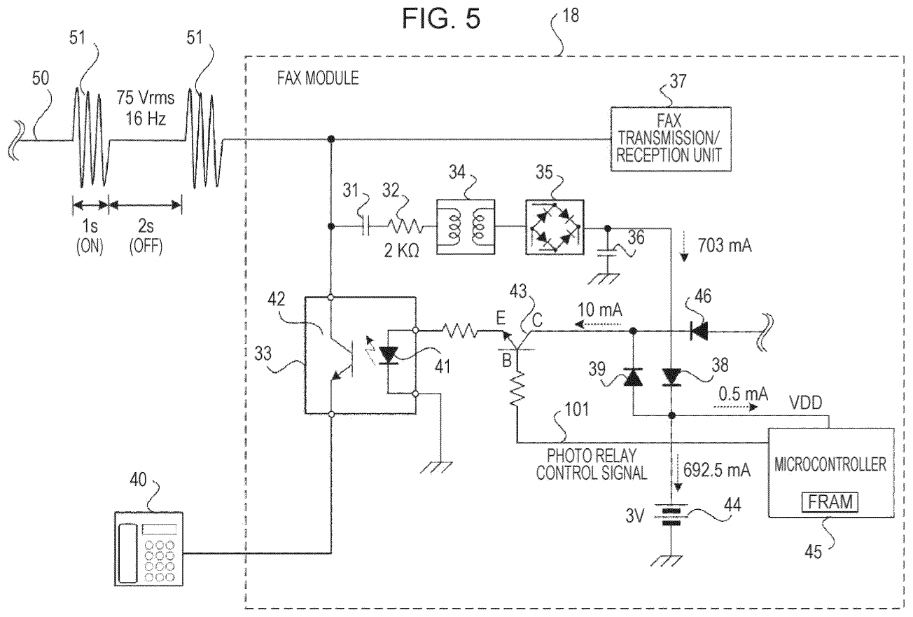

Next, a circuit configuration of the FAX module 18 in the image forming apparatus 10 according to this exemplary embodiment will be described with reference to FIG. 5. In FIG. 5, component elements having the same functions as those of component elements illustrated in FIG. 4 are denoted by the same signs, and detailed description of those component elements will be omitted.

As illustrated in FIG. 5, the FAX module 18 in this exemplary embodiment includes a capacitor 31, a resistor element 32, the photo relay 33, an insulating transformer 34, a diode bridge 35, a smoothing capacitor 36, the FAX transmission/reception unit 37, diodes 38, 39, and 46, a transistor 43, a rechargeable battery 44, and a low-power FRAM (ferroelectric random access memory)-embedded microcontroller 45. In FIG. 5, a circuit corresponding to the off-hook detection circuit 143 illustrated in FIG. 4 is omitted.

In the FAX module 18 in this exemplary embodiment, since the photo relay 33 is turned on using electric power of a signal at the time when an incoming call from the telephone line 50 arrives, the telephone set 40 is connected to the telephone line 50 and is thus enabled to be used even in a power outage when commercial power is not supplied to the image forming apparatus 10.

The signal at the time when an incoming call from the telephone line 50 arrives is a call signal or an information reception terminal activation signal (CAR signal). The call signal is a signal for informing the telephone set 40 of arrival of an incoming call. The CAR signal is a signal that is transmitted, before the telephone set 40 is informed of arrival of an incoming call, for activating the telephone set 40, so that a caller ID display function is enabled.

As illustrated in FIG. 5, a call signal is standardized such that the same signal is transmitted repeatedly with a cycle in which a sinusoidal wave with an amplitude of 75 Vrms and a frequency of 16 Hz is transmitted for 1 second and then an OFF state lasts for 2 seconds.

The capacitor 31 is provided to block the DC voltage of the telephone line 50. The resistor element 32 of 2 kΩ is provided between the capacitor 31 and the insulating transformer 34. With the insulating transformer 34 and the photo relay 33, electrical insulation between a circuit inside the FAX module 18 and the telephone line 50 is achieved.

Also in this exemplary embodiment, the photo relay 33 performs an operation for switching the state of connection between the externally connected telephone set 40 and the telephone line 50.

A rectifying unit including the diode bridge 35 and the smoothing capacitor 36 rectifies a signal at the time when an incoming call from the telephone line 50 arrives into DC power.

The rechargeable battery 44 functions as a holding unit that holds the DC power obtained by rectification by the rectifying unit. Instead of the rechargeable battery 44, a large-capacity capacitor may hold the DC power obtained rectification by the rectifying unit.

The DC power obtained by rectification by the diode bridge 35 and the smoothing capacitor 36 is supplied to the rechargeable battery 44 via the diode 38. Furthermore, the DC power obtained by rectification by the diode bridge 35 and the smoothing capacitor 36 is also supplied as power supply for the FRAM-embedded microcontroller 45.

As described above, the FRAM-embedded microcontroller 45 is a processor that performs activation using electric power held in the rechargeable battery 44.

The FRAM-embedded microcontroller 45 operates in such a manner that when a photo relay control signal 101 is set to high level (hereinafter, represented by H) and the transistor 43 is thus turned on, electric power held in the rechargeable battery 44 is supplied to the light-emitting element 41 of the photo relay 33 via the diode 39.

The base of the transistor 43 is connected to the photo relay control signal 101 from the FRAM-embedded microcontroller 45 with a resistor element interposed therebetween, the collector of the transistor 43 is connected to the cathodes of the diodes 39 and 46, and the emitter of the transistor 43 is connected to the light-emitting element 41 of the photo relay 33.

Since the transistor 43 is connected as described above, the transistor 43 functions as a switching element that is turned on in accordance with the photo relay control signal 101 output from the FRAM-embedded microcontroller 45 and supplies electric power held in the rechargeable battery 44 to the photo relay 33.

The FRAM-embedded microcontroller 45 and the transistor 43 function as a switching controller that performs control in such a manner that when the DC power held in the rechargeable battery 44 is supplied to the photo relay 33, the externally connected telephone set 40 is connected to the telephone line 50.

The FRAM-embedded microcontroller 45 includes an FRAM, which is a nonvolatile memory, and operates in such a manner that the transistor 43 is turned on when a period of time corresponding to a delay setting time A, which is set in the embedded FRAM, has passed, so that electric power is supplied to the photo relay 33.

The switching controller may be configured without including the FRAM-embedded microcontroller 45. For example, the switching controller may include a time measuring circuit, such as a timer IC or a reset IC, that operates using electric power held in the rechargeable battery 44, instead of including the FRAM-embedded microcontroller 45. With the configuration described above, the transistor 43, which is a switching element, is turned on in accordance with a signal output from the time measuring circuit and thus supplies electric power held in the rechargeable battery 44 to the photo relay 33.

The time measuring circuit mentioned above may be configured such that the period of time from the time at which electric power is held in the rechargeable battery 44 to the time at which a signal for turning on the transistor 43 is output from the rechargeable battery 44 is set according to a time constant based on a capacitor and a resistor element.

Electric power for turning on the light-emitting element 41 of the photo relay 33 in a normal condition, which is not in a power outage, is supplied via the diode 46 and supplied via the transistor 43 to the photo relay 33.

With the circuit configuration described above, even in the case where power is not supplied to the image forming apparatus 10 in a power outage, the photo relay 33 is temporarily turned on using electric power of a signal at the time when an incoming call from the telephone line 50 arrives. As a result, even with the configuration in which the state of connection between the externally connected telephone set 40 and the telephone line 50 is switched by the photo relay 33, the telephone set 40 can be connected to the telephone line 50 and is thus enabled to be used in a power outage.

However, the period of time during which the telephone set 40 is able to be used in a power outage depends on the amount of electric power held in the rechargeable battery 44.

A description about how long electric power supplied in one cycle of a call signal including 1-second ON and 2-second OFF as described above enables the telephone set 40 to be used will be provided below.

### [1-Second ON Period]

During the 1-second ON period of a call signal, a sinusoidal wave with an amplitude of 75 Vrms and a frequency of 16 Hz is transmitted as described above. Electric power that is able to be acquired from the call signal during the 1-second ON period is calculated based on the call signal with the amplitude of 75 Vrms and the resistor element 32 with the resistance value of 2 kΩ:

P=V·V/R=75 Vrms·75 Vrms/2 kΩ=2812 mWrms.

In this exemplary embodiment, the case where the rechargeable battery 44 holds the voltage of 3 V will be described. Taking into consideration a voltage drop corresponding to a forward voltage by the diode 38, it is assumed that the rectifying unit including the diode bridge 35 and the smoothing capacitor 36 performs rectification into the DC voltage of 4 V. In this case, the sum of the current I supplied from the rectifying unit via the diode 38 to the rechargeable battery 44, the FRAM-embedded microcontroller 45, and the photo relay 33 is 703 mA, based on an equation:

I=P/V=2812 mWrms/4 V=703 mA.

Provided that a current required for the photo relay 33 to be turned on is 10 mA and a current required for the FRAM-embedded microcontroller 45 to operate is 0.5 mA, a current of 692.5 mA is able to be charged in the rechargeable battery 44.

### [2-Second OFF Period]

During the 2-second OFF period of a call signal, 20 mA is consumed by the photo relay 33 and 1 mA is consumed by the FRAM-embedded microcontroller 45. In this case, the electric power stored in the rechargeable battery 44 is reduced to the amount corresponding to a current of 671.5 mA.

As described above, during the period in which no call signal is transmitted from the telephone line 50, electric power held in the rechargeable battery 44 is kept consumed at an amount of 10.5 mA per second. That is, in the case where the photo relay 33 is turned on using electric power from a call signal of one cycle of 1-second ON and 2-second OFF, the telephone set 40 and the telephone line 50 are able to be connected for only about 65 seconds. If the photo relay 33 is turned on after five cycles of the call signal, the telephone set 40 and the telephone line 50 are able to be connected for only about 400 seconds.

If the photo relay 33 is turned on immediately after a call signal is transmitted from the telephone line 50 in a power outage, a user who has noticed arrival of the incoming call picks up the call, resulting in failing in transmission of the call signal. That is, by causing electric power to be held in the rechargeable battery 44 without turning on the photo relay 33 immediately after a call signal is transmitted from the telephone line 50 in a power outage, the amount of electric power held in the rechargeable battery 44 is increased. However, if the period of time until the photo relay 33 is turned on is too long, a call originator might give up and terminate the call.

Thus, the FRAM-embedded microcontroller 45 in this exemplary embodiment is capable of adjusting the period of time from the time at which activation is performed by supply of electric power to the time at which the photo relay 33 is turned on in accordance with the photo relay control signal 101 at the H level.

As described above, the FRAM-embedded microcontroller 45 holds the delay setting time A, which is a set value, in the embedded FRAM. The FRAM-embedded microcontroller 45 operates in such a manner that the transistor 43 is turned on when a period of time corresponding to the delay setting time A, which is set in the embedded FRAM, has passed and electric power is supplied to the photo relay 33.

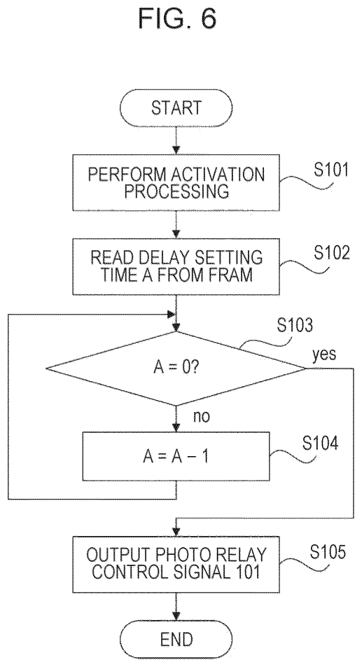

An operation of the FRAM-embedded microcontroller 45 for the case where the control described above is performed will be described with reference to a flowchart of FIG. 6.

When power is supplied, the FRAM-embedded microcontroller 45 performs activation processing in step S101. Then, in step S102, the FRAM-embedded microcontroller 45 reads the value of the delay setting time A from the embedded FRAM.

Next, in step S103, the FRAM-embedded microcontroller 45 determines whether or not the delay setting time A is 0. In this case, since the delay setting time A is not 0, the FRAM-embedded microcontroller 45 decrements the delay setting time A by one in step S104, and returns to the processing of step S103. When a period of time corresponding to the delay setting time A has passed by performing the processing of steps S103 and S104 repeatedly, if it is determined in step S103 that the delay setting time A is 0, the FRAM-embedded microcontroller 45 outputs the photo relay control signal 101, that is, sets the photo relay control signal 101 to the H level, in step S105.

The user is able to set the delay setting time A, which is a set value, to a desired value. Thus, the user is able to set in a desired manner the period of time from the time at which an incoming call signal is transmitted to the time at which the photo relay 33 is turned on so that the incoming call signal reaches the telephone set 40. The period of time until connection of the telephone set 40 to the telephone line 50 is set to be longer by increasing the value of the delay setting time A. However, a call originator might terminate a call because of too much wait time. Hence, the delay setting time A needs to be set taking into consideration the balance between the wait time for a call originator and the amount of electric power to be charged.

As described above, every time receiving a call signal, the FAX module 18 in this exemplary embodiment temporarily enables the telephone set 40 to be used due to electric power of the call signal. Thus, the rechargeable battery 44 does not need to have a large capacity. That is, the configuration capable of enabling the telephone set 40 to be used when power is out, without requiring a large capacity of backup power supply charged in advance, is achieved. Thus, both a reduction in the size of the FAX module 18 and dealing with power outage are achieved.

The term “system” in an exemplary embodiment includes both a system including a plurality of apparatuses and a system formed of a single apparatus.

### Modifications

A case where the present disclosure is applied to the image forming apparatus 10 including the facsimile function has been described in an exemplary embodiment described above. However, the present disclosure is not limited to the case described above. The present disclosure is also applicable in a similar manner to any facsimile apparatus including the facsimile function, such as a facsimile apparatus provided with only the facsimile function or a facsimile apparatus integrated with a telephone set.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

A facsimile apparatus comprising:
a photo relay that switches a state of connection between an externally connected telephone set and a telephone line;
a rectifying unit that rectifies a signal at a time when an incoming call from the telephone line arrives into DC power;
a holding unit that holds the DC power obtained by rectification by the rectifying unit; and
a switching controller that performs control in such a manner that supply of the DC power held in the holding unit to the photo relay causes the externally connected telephone set to be connected to the telephone line.
   (((2)))

The facsimile apparatus according to (((1))), wherein the switching controller includes:
a processor configured to perform activation using the electric power held in the holding unit; and
a switching element that is turned on in accordance with a signal output from the processor and supplies the electric power held in the holding unit to the photo relay.
   (((3)))

The facsimile apparatus according to (((2))), wherein the processor is configured to include a nonvolatile memory embedded and operate in such a manner that the switching element is turned on when a period of time set in the embedded nonvolatile memory has passed and the electric power is supplied to the photo relay.

(((4)))

The facsimile apparatus according to (((1))), wherein the switching controller includes:
a time measuring circuit that operates using the electric power held in the holding unit; and
a switching element that is turned on in accordance with a signal output from the time measuring circuit and supplies the electric power held in the holding unit to the photo relay.
   (((5)))

The facsimile apparatus according to (((4))), wherein in the time measuring circuit, a period of time from a time at which the electric power is held in the holding unit to a time at which a signal for turning on the switching element is output from the holding unit is set according to a time constant based on a capacitor and a resistor element.

(((6)))

The facsimile apparatus according to any one of (((1))) to (((5))), wherein the signal at the time when the incoming call from the telephone line arrives is a call signal or an information reception terminal activation signal.

What is claimed is:

1. A facsimile apparatus comprising:
a photo relay that switches a state of connection between an externally connected telephone set and a telephone line;
a rectifying unit that rectifies a signal at a time when an incoming call from the telephone line arrives into DC power;
a holding unit that holds the DC power obtained by rectification by the rectifying unit; and
a switching controller that performs control in such a manner that supply of the DC power held in the holding unit to the photo relay causes the externally connected telephone set to be connected to the telephone line.

2. The facsimile apparatus according to claim 1, wherein the switching controller includes:
a processor configured to perform activation using the electric power held in the holding unit; and
a switching element that is turned on in accordance with a signal output from the processor and supplies the electric power held in the holding unit to the photo relay.

3. The facsimile apparatus according to claim 2, wherein the processor is configured to include a nonvolatile memory embedded and operate in such a manner that the switching element is turned on when a period of time set in the embedded nonvolatile memory has passed and the electric power is supplied to the photo relay.

4. The facsimile apparatus according to claim 1, wherein the switching controller includes:
a time measuring circuit that operates using the electric power held in the holding unit; and
a switching element that is turned on in accordance with a signal output from the time measuring circuit and supplies the electric power held in the holding unit to the photo relay.

5. The facsimile apparatus according to claim 4, wherein in the time measuring circuit, a period of time from a time at which the electric power is held in the holding unit to a time at which a signal for turning on the switching element is output from the holding unit is set according to a time constant based on a capacitor and a resistor element.

6. The facsimile apparatus according to claim 1, wherein the signal at the time when the incoming call from the telephone line arrives is a call signal or an information reception terminal activation signal.

7. A facsimile apparatus comprising:
photo relay means for switching a state of connection between an externally connected telephone set and a telephone line;
rectifying means for rectifying a signal at a time when an incoming call from the telephone line arrives into DC power;
holding means for holding the DC power obtained by rectification by the rectifying means; and
switching control means for performing control in such a manner that supply of the DC power held in the holding means to the photo relay means causes the externally connected telephone set to be connected to the telephone line.
